(19) United States
(12) Patent Application Publication
(10) Pub. No.: US 2014/0277704 A1
(43) Pub. Date: Sep. 18, 2014

(54) PRODUCT VENDING APPARATUS

(71) Applicant: Omeed Memar, Chicago, IL (US)

(72) Inventor: Omeed Memar, Chicago, IL (US)

(21) Appl. No.: 14/216,238

(22) Filed: Mar. 17, 2014

Related U.S. Application Data
(60) Provisional application No. 61/789,744, filed on Mar. 15, 2013.

(51) Int. Cl. B01F 13/10

(52) U.S. Cl. CPC B01F 13/1063
USPC 700/233

(57) ABSTRACT

A product vending machine apparatus includes an ingredients cartridge storage area, a product container storage area, and a preparation mechanism. The preparation mechanism selects one or more individual, prepackaged cartridges of active and/or inactive ingredients and dispenses the ingredients into a product container selected based on the product selected by the customer. The preparation mechanism does not come into contact with the ingredients as they are dispensed into the product container.

### PRIORITY

This application claims priority under 35 U.S.C. §119(e) to U.S. Provisional Application Ser. No. 61/789,744, filed Mar. 15, 2013, which is expressly incorporated by reference herein.

### BACKGROUND

The present disclosure relates to a product vending apparatus, and in particular to a product vending apparatus that can dispense various types of products to consumers. More particularly, the present disclosure relates to a product vending apparatus that can blend ingredients to create various types of products based on a consumer's product selection.

### SUMMARY

A product vending machine apparatus in accordance with the present disclosure includes an ingredients cartridge storage area, a product container storage area, and a preparation mechanism. In illustrative embodiments, the product vending apparatus permits a customer to select a particular type of product from a variety of products available. After a customer selects and pays for the product, the preparation mechanism located inside the product vending machine selects one or more individual, prepackaged cartridges of active and/or inactive ingredients and dispenses the ingredients into a product container selected based on the product selected by the customer. The preparation mechanism does not come into contact with the ingredients as they are dispensed into the product container. The product vending machine then disposes of the emptied cartridge(s) and dispenses the product to the customer.

In illustrative embodiments, the preparation mechanism retrieves one or more prepackaged cartridges from the ingredients cartridge storage area that includes different types of cartridges that hold different types or amounts of ingredients. Similarly, the preparation mechanism retrieves a product container from the product container storage area that includes different types of product containers. The containers in the product container storage area may also include a base ingredient to be mixed with the ingredients from the prepackaged cartridges as well as a product applicator. The preparation mechanism may agitate or mix the ingredients together in the product container before dispensing the product container to the consumer. The preparation mechanism ensures that no cross contamination occurs during the entire preparation process.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of an illustrative embodiment of a product vending apparatus of the present disclosure;

FIG. 2 is a perspective view of the product vending apparatus of FIG. 1 showing the product vending apparatus opened to reveal an interior region of the product vending apparatus;

FIG. 3 is a view similar to FIG. 2 showing the product vending apparatus transferring the contents of an individual cartridge into a product container;

FIG. 4 is a view similar to FIG. 3 showing disposal of the ingredient cartridge and agitation of the product container containing the ingredient;

FIG. 5 is a view similar to FIG. 4 showing dispensing of the finished product;

FIG. 6 is a perspective view of the portion of the product vending apparatus of FIG. 2 showing the product vending apparatus performing a second operation, the second operation including selecting an individual cartridge of a predetermined volume of ingredient and selecting a tube-type product container that receives the ingredient from the individual cartridge;

FIG. 7 is a view similar to FIG. 6 showing the product vending apparatus sealing an open end of the tube-type product container;

FIG. 8 is a view similar to FIG. 7 showing the product vending apparatus squeezing the tube-type product container to disperse the ingredient throughout the second type of product container; and

FIG. 9 is a schematic view of the operations of the product vending apparatus in accordance with the present invention.

### DETAILED DESCRIPTION

A product vending apparatus 10 of the present disclosure includes a shell 12, an ingredients cartridge storage area 14, a product container storage area 16, and a preparation mechanism 18, as illustrated, for example, in FIGS. 1 and 2. The product vending apparatus 10 is configured to permit a customer to select a type of product P and to dispense the selected product P to the consumer by customizing the product P inside the vending apparatus 10 through use of individual, prepackaged vials or cartridges 20 of a predetermined volume of ingredients 22. As illustrated in FIG. 2, the vending apparatus 10 selects the individual, prepackaged cartridges 20 from the ingredients cartridge storage area 14 based on a formulation of the desired product P chosen by the customer. The vending apparatus 10 then dispenses the ingredients 22 from the prepackaged cartridges 20 into a product container 40 from the product container storage area 16, the product container 40 also being selected based on the product P chosen by the customer. The vending apparatus 10 would ensure the ingredients 22 are thoroughly mixed or dispersed throughout the product container 40 of the product P and then dispense the product P to the customer. Mixing can occur by use of a disposable mixing stir or can be accomplished through shaking or kneeding. By utilizing prepackaged cartridges 20 of predetermined volumes of ingredients 22 and mixing the ingredients 22 directly into the product containers 40, the product vending apparatus 10 can provide for a variety of possible products P while avoiding cross-contamination issues from different ingredients 22.

In illustrative embodiments, the product vending apparatus 10 is configured to allow a user to select a product P for purchase. Products P can include medicated and non-medicated dermatologic treatments and cosmetics in the form of liquids or creams and includes, lotions, oils, hair care products, skin treatments soaps, shampoos, perfumes and colognes. The products P available for purchase from the product vending apparatus 10 are products that can be created through mixing of one or more ingredients 22 stored in the prepackaged cartridges 20. The products P may also include products that can be created through mixing an ingredient 22, an active ingredient, with a base ingredient 23, a non-active ingredient, such as water, colorant, alcohol or petroleum, for example. The base ingredient 23 may be separately dispensed into the product containers 40 or may already be located in the product containers 40 prior to selection of a product container 40.

The prepackaged cartridges 20 are configured to hold a predetermined volume of ingredients 22 that can be easily combined with other predetermined volumes of ingredients 22 or a base ingredient 23 to create a specific product P. For example, one type of ingredient 22a may be salicylic acid, and prepackaged cartridges 20a may each include a predetermined volume of 0.1 milliliters of salicylic acid. If a consumer chooses a product requiring 0.2 milliliters of salicylic acid in a petroleum base 23a, the product vending apparatus 10 would dispense two cartridges 20a of 0.1 milliliters of salicylic acid into a product container 40a. This allows the apparatus 10 to prepare mixtures with a certain percentage of active ingredients. The product container 40a may already include a standard amount of petroleum base 23a or petroleum 23a may be added by the product vending apparatus 10 after the user selects a product P. The product vending apparatus 10 would dispose of the emptied cartridges 20a and thoroughly mix or distribute the salicylic acid ingredient 22a throughout the petroleum base 23a in the product container 40a.

The shell 12 of the product vending apparatus 10 includes a housing 50 and a door 52 coupled to the housing 50 by a set of hinges 54 or any other suitable method, as illustrated in FIGS. 1 and 2. The door 52 may be closed and locked to prevent unwanted access into an interior region 56 defined by the housing 50 and the door 52, and the door 52 may be opened to expose access to the interior region 56 and replenish prepackaged cartridges 20 and product containers 40. The door 52 may include an input panel 60, a payment panel 62, and dispensing door 64. As with standard vending machines and as illustrated in FIG. 1, the product vending apparatus 10 may also include a viewing window 66 on the door 52 to see into the interior region 56 of the housing 50. The door 52 may also include prominent indicia 68 to inform customers of the products P available from the vending apparatus 10.

In illustrative embodiments, the input panel 60 of the product vending apparatus 10 includes a touch screen panel 61 that provides a customer with various choices of cosmetic or other dermalogical products P that can be created through the combination of prepackaged ingredients 22 inside the product vending apparatus 10. Other types of input panels 60 may also be used to allow a user to select a product P. After a user selects a type of product P from the input panel 60, the product vending apparatus 10 will require the user to pay for the product P via the payment panel 62. The payment panel 62 may include a credit/debit card reader 63, a cash reader 65, or any other suitable type of payment collection apparatus, as illustrated in FIG. 1. The input panel 60 and the payment panel 62 may also be combined into one multipurpose panel. Various other embodiments of a selection and payment process are also envisioned.

As illustrated in FIG. 2, the interior region 56 of the product vending apparatus 10 includes the ingredients cartridge storage area 14, the product container storage area 16, and the preparation mechanism 18. In illustrative embodiments, the preparation mechanism 18 is configured to be electronically coupled to the input panel 60 through use of communication circuitry 32. When a customer selects a particular type of product P, the preparation mechanism 18 is controlled through the communication circuitry 32 to select the appropriate prepackaged cartridge(s) 20 and product container 40 for the product P chosen. Other various forms of controlling the selection of appropriate prepackaged cartridge(s) 20 and product containers 40 are envisioned.

The preparation mechanism 18 may be configured in any form to provide the appropriate selection and preparation functions. Preparation mechanism 18 may include a pair of perpendicular tracks 46, 48 that allow a shuttle 49 to freely move about the interior region 56. Track 46 permits movement of shuttle 49 along an x-axis 70 and track 48 permits movement of shuttle 49 along a y-axis 72. Shuttle 49 may be configured to move along both tracks 46, 48 to select, prepare, and dispense ingredients 22 or product P.

After receiving a customer's selection of and payment for a particular product P, the preparation mechanism 18 is configured to select the appropriate prepackaged cartridge(s) 20 of ingredients 22 from the ingredients cartridge storage area 14. In particular, the preparation mechanism 18 may select one or more prepackaged cartridge(s) 20 from the ingredients cartridge storage area 14. The ingredients cartridge storage area 14 may include multiple types of prepackaged cartridges 20 with different types of ingredients 22 (e.g. prepackaged cartridges 20a, prepackaged cartridges 20b, prepackaged cartridges 20c, etc), as illustrated in FIG. 2.

In illustrative embodiments, the preparation mechanism 18 will also select a product container 40 from the product container storage area 16. This selection may occur before, at the same time, or after the selection of the appropriate prepackaged cartridge(s) 20 from the ingredients cartridge storage area 14. The product container storage area 16 may include multiple types of product containers 40 (e.g. product containers 40a, product containers 40b, product containers 40c, etc), as illustrated in FIG. 2. The product containers 40 may also include one or more types of base ingredients 23 (e.g. base ingredient 23a, base ingredient 23b, base ingredient 23c, etc) before selection or such base ingredients 23 may be added after selection. In illustrative embodiments, the product containers 40 may also include additional medium 25 for ingredients 22 to be received onto, such as cotton swaps or pads.

As illustrated in FIG. 2, the preparation mechanism 18 is configured to empty the ingredients 22 from the selected prepackaged cartridge 20 into the selected product container 40. In illustrative embodiments, the preparation mechanism 18 may perform this function by squeezing or shaking the prepackaged cartridge 20 such that the ingredients 22 are distributed into the product container 40. The preparation mechanism 18 will not touch or come into contact with the ingredients 22 when distributing the ingredients 22 into the product container 40. Other possible distribution means are also envisioned to empty the prepackaged cartridge 20 without requiring the preparation mechanism 18 to make contact with the ingredients 22 inside the prepackaged cartridges 20. In this way, the preparation mechanism 18 avoids cross-contamination issues for future products P prepared in the product vending apparatus 10.

Once the preparation mechanism 18 empties ingredients 22 from the prepackaged cartridge 20 into the product container 40, the preparation mechanism 18 discards the emptied cartridge 20 into a waste or refuse bin 24 located in the interior region 56 of the product vending apparatus 10, as illustrated in FIG. 2. The refuse bin 24 is configured to hold emptied cartridges 20 until they can be removed from the product vending apparatus 10 to be recycled or refilled for future use. If additional prepackaged cartridges 20 are required to create the specific product P selected by the customer, the preparation mechanism 18 repeats the process of selecting additional cartridges 20 from the ingredients cartridge storage area 14, emptying the ingredients 22 from those cartridges 20 into the product container 40 without touching the ingredients 22 within the cartridges 20, and discarding the emptied cartridges 20 into the product container 40.

Once the proper amount of ingredients 22 has been dispensed into the product container 40, the product container 40 is sealed or closed. In one illustrative embodiment, the product container 40 may be a valve or screw-cap bottle 30, as illustrated in FIG. 2. In an alternative illustrative embodiment, the product container 40 may be a tube-shaped container 34, and the product container 40 may be sealed by heat seating a open end 36 of the tube 34 that is opposite of a recloseable end 38 of the tube 34, as illustrated in FIGS. 6-8. After sealing the product container 40, the preparation mechanism 18 agitates, squeezes, or shakes the product container 40 to properly distribute the ingredients 22 throughout the product container 40. If the vending apparatus 10 is missing one or more ingredients 22, it will not prepare and dispense the product P.

After the ingredients 22 have been properly distributed throughout the product container 40, the preparation mechanism 18 places the product container 40 into a dispensing bin 26 located at a bottom area 58 of the interior region 56 of the product vending apparatus 10. The dispensing bin 26 corresponds to the dispensing door 64 of the door 52 of the product vending apparatus 10. A customer can then open the dispensing door 64 and collect the product container 40 containing the selected product P. A trap or blocking panel 28 may be coupled to the top of the dispensing bin 26 to prevent access into the interior region 56 from the dispensing bin 26.

While the use of vending apparatus is shown for use with medicated and non-medicated products, the same technology can be used with prescription medications or various types. In one embodiment, a physican sends a prescription electronically to the vending apparatus via a web based connection. When the user approaches the vending apparatus, the provides personal identification in the form of an identification card or code provided by the physician so that the vending apparatus can confirm that the correct user is present and using the vending apparatus. Once the user is identified, the vending apparatus prepares the prescription medication as prescribed by the physician.

In order to avoid confusion when filing the vending apparatus with the proper active and inactive ingredients, the cartridges have predetermined shapes that only fit in certain storage areas of the vending apparatus or rfid tags or other indicia that are recognized by the vending apparatus to prevent improper filling. This prevents the placement of ingredients in the wrong storage areas of the vending apparatus.

Although directional language may be used throughout the specification, such directions are intended to convey the scope of the present disclosure rather than limit the scope of the present disclosure. It should be understood that a direction, such as up, down, back, front, etc., may change depending on the orientation of one or more components of the product vending apparatus disclosed herein.

Various features of the disclosure have been shown and described in connection with the illustrated embodiment, however, it is understood that these arrangements merely illustrate, and that the disclosure is to be given its fullest interpretation.

What is claimed is:

1. A product vending apparatus comprising:
a housing having a user interface to allow a user to select one of several types of products;
the housing including an ingredients storage area for storing one or more types of ingredients for use in the product;
the housing including a product container storage area for storing product containers for use with the product;
a preparation mechanism for combining one or more of the ingredients into one of the product containers wherein the preparation mechanism does not cause cross contamination of the ingredients with other ingredients during filing the product container;
wherein the product vending apparatus is adapted to permit a customer to select a type of product by using the user interface and to dispense the selected product to the consumer by customizing the product inside the vending apparatus and the preparation of one product does not cause cross contamination of subsequently prepared products.

2. The product vending apparatus of claim 1, wherein the ingredients are stored in individual prepackaged containers.

3. The product vending apparatus of claim 2, wherein the prepackaged containers contain a predetermined volume of the ingredients.

4. The product vending apparatus of claim 3, wherein the preparation mechanism may use one or more of the prepackaged containers when preparing the product.

5. The product vending apparatus of claim 1, wherein the vending apparatus selects one or more individual, prepackaged ingredient cartridges from the ingredients storage area based on a formulation of the desired product chosen by the user.

6. The product vending apparatus of claim 5, wherein the vending apparatus dispenses the ingredients from the prepackaged ingredient cartridges into the product container from the product container storage area.

7. The product vending apparatus of claim 6, wherein the type of product container used for a particular product is selected based upon the type of product selected by the user.

8. The product vending apparatus of claim 1, where the ingredients include active an non-active ingredients.

9. The product vending apparatus of claim 1, wherein the preparation mechanism includes a horizontal track and a perpendicular track and a shuttle that moves along the tracks in an interior region of the vending apparatus to select, prepare, and dispense ingredients or products.

10. The product vending apparatus of claim 2, wherein the containers have predetermined shapes that only fit into certain predetermined storage areas of the vending apparatus.

11. A product vending apparatus comprising:
a housing having a user interface to allow a user to select one of several types of products;
the housing including an ingredients storage area for storing one or more types of ingredients for use in the product;
the housing including a product container storage area for storing product containers for use with the product;
a preparation mechanism that is adapted to combine one or more of the ingredients into one of the product containers wherein the preparation mechanism does not cause any cross contamination of the ingredients; and
wherein the product vending apparatus is adapted to permit a customer to select a type of product by using the user interface and to dispense the selected product to the consumer by customizing the product inside the vending apparatus and the preparation of one product does not cause cross contamination of subsequently prepared products.

12. The product vending apparatus of claim 11, wherein the vending apparatus selects one or more individual, prepackaged ingredient cartridges from the ingredients storage area based on a formulation of the desired product selected by the user.

13. The vending apparatus of claim 12, wherein the vending apparatus dispenses the ingredients from the prepackaged ingredient cartridges into the selected product container.

14. The vending apparatus of claim 13, wherein the type of product container used for a particular product is selected based upon the type of product selected by the user.

15. The vending apparatus of claim 11, wherein the ingredients include active an non-active ingredients.

16. The vending apparatus of claim 11, where the vending apparatus includes a module that accepts an electronic prescription sent from a physician and then positively identifies and assicates a user with the prescription and prepares and dispenses a product identified in the prescription to the identified user.
